(19) United States
(12) Patent Application Publication
(10) Pub. No.: US 2021/0321318 A1
(43) Pub. Date: Oct. 14, 2021

(54) Alternative Addressing of Managed Objects

(71) Applicant: Telefonaktiebolaget LM Ericsson (publ), Stockholm (SE)

(72) Inventors: Nicklas Johansson, Brokind (SE); Peter Loborg, Linköping (SE); Edwin Tse, Montreal (CA); Robert Petersen, Linköping (SE)

(21) Appl. No.: 17/261,092

(22) PCT Filed: Aug. 2, 2019
(86) PCT No.: PCT/IB2019/056622

§ 371 Date: Jan. 18, 2021

Related U.S. Application Data
(60) Provisional application No. 62/717,323, filed on Aug. 10, 2018.

(51) Int. Cl. H04W 40/24; H04W 24/02; H04L 12/24; H04W 48/16; H04W 8/26

(52) U.S. Cl. CPC H04W 40/246; H04W 24/02; H04W 8/26; H04W 48/16; H04L 41/12

(57) ABSTRACT

A resource management system maintains an association between element-specific data and the corresponding element within a network independent of a physical or logical location of the corresponding element within the network to seamlessly accommodate changing locations of the element. For each of a plurality of elements in the network, the resource management system specifies a location-specific and a universally unique DN for the corresponding element, links element-specific data captured using the location-specific DN to element-specific data captured using the universally unique DN, stores the element-specific data relative to the universally unique DN in memory of the resource management system, links the universally unique to the corresponding location-specific DN to enable the resource management system to access the element-specific data stored relative to the universally unique DN using the location-specific DN, and stores the identified location-specific DN, the universally unique DN, and the corresponding linkings in the memory.

### RELATED APPLICATIONS

This application claims priority to U.S. Application No. 62/717323, filed 10 Aug. 2019, the disclosure of which is incorporated in its entirety by reference herein.

### TECHNICAL FIELD

The solution presented herein generally relates to wireless communications, and more particularly relates to maintaining an association between element-specific data and the corresponding element independently of the physical or logical location of the element within the network.

BACKGROUND In the area of network management, the so called Network Resource Model (NRM) is the basic foundation for management functionality such as Configuration Management (CM) and Performance Management. See FIG. 1, where a part of the cell view of the E-UTRAN NRM is illustrated. See also 3GPP TS 28.622 and TS 28.658. Performance Measurements, for example, for a given cell are referenced using the Distinguished Name (DN) which in turn is made up of several Relative Distinguished Names (RDNs) as per 3GPP TS 32.300.

FIG. 1 shows an illustration of a part of the cell view of E-UTRAN NRM. In FIG. 1, the Performance Measurements for a particular cell instance (the one with RDN=cell2 FIG. 1) would be referenced with SubNetwork=Subnet1, MeContext=Context1, ManagedElement=MEI, eNBFunction=Function1, eNBGenericCell=Cell2. Similarly, the management system would also use the reference SubNetwork=Subnet1, MeContext=Context1, ManagedElement=ME1, eNBFunction=Function1, eNBGenericCell=Cell2 to configure that particular cell.

Regardless of the radio access standard (e.g. GSM, UTRAN, EUTRAN, or NR) the Performance Indicators (P1) for a cell in the mobile network are used to count occurrences on several of the control layers. Examples on LTE layer 2 include PIs for “Number of Active UEs in the DL per QCI” in a Cell and “Total PRB usage” in a cell (see 3GPP TS 36.314). Examples on LTE layer 3 are PIs for “Attempted outgoing handovers per handover cause” and “Successful outgoing handovers per handover cause” (see 3GPP TS 32.425), both counted on the cell object.

Additionally, in the area of network management of radio nodes one common action is to move one or more cells from one base station to another, this is sometimes referred to as rehoming of cells. A similar operation occurs when changing deployment model for a base station between a single node deployment of a NR node and a three-split deployment. This action is typically used when adding or reorganizing the base stations in a network to either modify capacity, to modify the coverage area or to modernize the equipment. This is called rehoming (reparenting) of NBs to RNCs in UMTS and BTSs to BSCs in GSM.

Furthermore, for 5G NR the radio control network function is proposed to be divided in a distributed unit (DU) and a centralized unit (CU), where the CU can be further decomposed into a control plane function (CU-CP) and a user plane function (CU-UP), see 3GPP TS 38.401 v15.2.0. In this architecture the cell object is proposed to have representation in both the DU and CU-CP, as the layer 2 functionality will mainly be implemented in the DU and layer 3 functionality in the CU-CP. As such, layer 2 and layer 3 PIs related to the same logical cell will be reported on two different object identifiers in the form of the Local Distinguished Names (LDNs) for the DU cell and CU-CP cell, respectively. The deployment of the 5G NR system can be done either as a single or collapsed node containing both the DU, CU-CP and CU-UP parts, or as several different nodes implementing one part each, or as any combination in-between. Typically, a gNB consists of a gNB-CU and one or more gNB-DUs and as the system grows the number of gNB-DUs connected to a single gNB-CU may eventually reach the capacity limit of the single gNB-CU. When that occurs a new gNB-CU needs to be instantiated in a data center and for load reasons one or more of the gNB-DUs connected to the old gNB-CU may have to be moved to the new gNB-CU, as shown in FIG. 2, which illustrates a move of gNB-DUs from gNB-CU #1 to gNB-CU #2 due to, e.g., load balancing. When this occurs the DNs of all gNB-DUs moved to the new gNB-CU will take on new names.

There currently exist certain challenge(s).

### SUMMARY

The solution presented herein addresses various problems with existing NRMs. One problem with the existing NRMs in, e.g., TS 28.655, TS 28.652, and TS 28.658, is that when, for example, a cell is moved from one base station to another or when one gNB-DU is moved from one gNB-CU to another gNB-CU, the DN also changes even if the cell is still the same.

In one exemplary embodiment, a method is performed by a resource management system to maintain an association between element-specific data and the corresponding element within a network independent of a physical or logical location of the corresponding element within the network to seamlessly accommodate changing locations of the element. The method comprises, for each of a plurality of elements in the network, specifying a location-specific DN and a universally unique DN for the corresponding element. The location-specific DN depends on a physical and/or a logical location of the corresponding element within the network and the universally unique DN comprises a Universal Unique Identifier (UUID) that is independent of the physical and/or logical location of the corresponding element within the network. The method further comprises, for each of the plurality of elements in the network, linking element-specific data captured using the location-specific DN for the corresponding element to element-specific data captured using the universally unique DN for the corresponding element, storing the element-specific data captured for a corresponding element relative to the universally unique DN in memory of the resource management system, linking the universally unique DN for the corresponding element to the location-specific DN for the corresponding element to enable the resource management system to access the element-specific data stored relative to the universally unique DN using the location-specific DN, and storing the identified location-specific DN, the universally unique DN, and the corresponding linkings in the memory of the resource management system.

In exemplary embodiments, the method further comprises, responsive to information indicating a new physical and/or logical location of one of the plurality of elements, changing the corresponding location-specific DN to determine an updated location-specific DN, linking the stored universally unique DN to the updated location-specific DN using a revised linking; and replacing the location-specific DN and the linking stored in memory with the updated location-specific DN and the revised linking, respectively.

In exemplary embodiments, at least one of the plurality of elements comprises a cell within the network, and the location-specific DN comprises a DN representing a generic cell, a generic Radio Access Network (RAN) node function, and a managed element.

In exemplary embodiments, at least one of the plurality of elements comprises a cell within the network, and the location-specific DN comprises a DN representing a generic cell, a generic Radio Access Network (RAN) node function, a managed element, a managed element context, and a subnetwork.

In exemplary embodiments, the generic RAN node function comprises an eNB function, a gNB function, a Base Station System (BSS) function, an NB function, a gNB-DU function, or a gNB-CU function.

In exemplary embodiments, the stored element-specific data includes connectivity information for the corresponding element. For such embodiments, the method further comprises, receiving a request to connect to an element in the network including a location-specific DN for the element, identifying the universally unique DN for the element using the received location-specific ON and the associated linking stored in the memory, retrieving the connectivity information for the element from the memory using the identified universally unique DN, and establishing a connection with the element using the retrieved connectivity information.

In exemplary embodiments, the method further comprises receiving the element-specific data from at least one element in the network, the received element-specific data including a location-specific DN for the element, and identifying the universally unique ON for the element using the received location-specific DN and the associated linking stored in the memory, where storing the element-specific data comprises storing the received data relative to the identified universally unique DN in the memory.

In exemplary embodiments, the element-specific data comprises performance measurements for the corresponding element and/or configuration information for the corresponding element.

In exemplary embodiments, the method further comprises receiving a notification from a managed element in the network, said notification identifying the location-specific DN and the universally unique DN for an element in the network, comparing the received location-specific DN for the element to the location-specific DN linked to the universally unique DN for the element, and modifying the location-specific DN and the corresponding linkings if the received location-specific DN does not match the stored location-specific DN for the element.

One exemplary embodiment comprises a resource management system configured to perform any of the above resource management system method steps.

One exemplary embodiment comprises a resource management system, the resource management system comprising processing circuitry and power supply circuitry. The processing circuitry is configured to perform any of the above resource management system method steps. The power supply circuitry is configured to supply power to the resource management system.

One exemplary embodiment comprises a resource management system comprising processing circuitry and memory. The memory contains instructions executable by the processing circuitry whereby the resource management system is configured to perform any of the above resource management system method steps.

One exemplary embodiment comprises a computer program for controlling a resource management system, where the computer program product comprises instructions which, when executed by at least one processor of the resource management system, causes the resource management system to carry out any of the above resource management system method steps. In exemplary embodiments, the computer program may be comprised in a carrier, wherein the carrier is one of an electronic signal, optical signal, radio signal, or computer readable storage medium. In some embodiments, the computer readable storage medium is non-transitory.

One exemplary method, performed by a managed element in a network, comprises sending a notification to a resource management system in the network, the notification identifying a location-specific Distinguished Name (DN) and the universally unique DN for the managed element in the network at least each time the location-specific DN changes.

In exemplary embodiments, the method further comprises the managed element receiving an access request, wherein the received access request specifies the location-specific DN and/or the universally unique DN for the element.

One exemplary embodiment comprises a managed element configured to perform any of the above managed element method steps.

One exemplary embodiment comprises a managed element, the resource management system comprising processing circuitry and power supply circuitry. The processing circuitry is configured to perform any of the above managed element method steps. The power supply circuitry is configured to supply power to the managed element.

One exemplary embodiment comprises a managed element comprising processing circuitry and memory. The memory contains instructions executable by the processing circuitry whereby the processing circuitry is configured to perform any of the above managed element method steps.

One exemplary embodiment comprises a computer program comprising instructions which, when executed by at least one processor of a managed element, causes the managed element to carry out any of the above managed element method steps. In exemplary embodiments, the computer program may be comprised in a carrier, wherein the carrier is one of an electronic signal, optical signal, radio signal, or computer readable storage medium. In some embodiments, the computer readable storage medium is non-transitory.

In exemplary embodiments, the managed element comprises a Radio Access Node or a Control Node.

Certain embodiments may provide one or more of the following technical advantage(s).

The benefit, if the proposed naming scheme is properly used, will be that the total Network Resource Model for an entire radio and core network will consist of a base tree of smaller models, where each smaller model (a sub-tree in its own right) will have a local root with globally unique identity, which can be used as the global root for elements within the local tree. This allows the base tree to be restructured. As the path of the base tree is no longer used for referencing the content of the sub-trees the restructuring operation is cheap as it does not affect stored references to the sub-trees.

As one example, there is no loss of reference of historical data in the management system, nor is there a need to change any of the management commands or scripts when moving one gNB-DU from one gNB-CU to another gNB-CU or when changing the deployment between a split and collapsed deployment of a 5G NR radio system.

Another example is that there is no loss of reference of historical data in the management system, nor is there a need to change any of the management commands or scripts when moving one base station (BTS or NB) from one radio control node (BSC or RNC) to another radio control node.

### BRIEF DESCRIPTION OF THE DRAWINGS

FIG. 1 shows a part of a cell view of an E-UTRAN NRM.

FIG. 2 shows an exemplary 5G NR divided into distributed and centralized units.

FIG. 3 shows an exemplary method implemented by a resource management system according to one or more exemplary embodiments.

FIG. 4 shows an exemplary method implemented by a managed element according to one or more exemplary embodiments.

FIG. 5 shows a resource management system according to one or more exemplary embodiments.

FIG. 6 shows a resource management system according to one or more exemplary embodiments.

FIG. 7 shows a managed element according to one or more exemplary embodiments.

FIG. 8 shows a managed element according to one or more exemplary embodiments.

FIG. 9 shows an exemplary wireless network applicable to the solution presented herein.

FIG. 10 shows an exemplary UE applicable to the solution presented herein.

FIG. 11 shows an exemplary virtualization environment applicable to the solution presented herein.

FIG. 12 shows an exemplary telecommunications network applicable to the solution presented herein.

FIG. 13 shows an exemplary host computer applicable to the solution presented herein.

FIG. 14 shows an exemplary method implemented in a communication system in accordance with embodiments of the solution presented herein.

FIG. 15 shows another exemplary method implemented in a communication system in accordance with embodiments of the solution presented herein.

FIG. 16 shows another exemplary method implemented in a communication system in accordance with embodiments of the solution presented herein.

FIG. 17 shows another exemplary method implemented in a communication system in accordance with embodiments of the solution presented herein.

### DETAILED DESCRIPTION

The solution presented herein addresses various problems with existing NRMs. One problem with the existing NRMs in, e.g., TS 28.655, TS 28.652, and TS 28.658, is that when, for example, a cell is moved from one base station to another or when one gNB-DU is moved from one gNB-CU to another gNB-CU, the DN also changes even if the cell is still the same. The reason for this is that the RDN of the new base station is part of the DN of the cell. In other words, Performance Measurements, Alarms, etc. sent to the management system will all be using a new DN for the same cell. One consequence of this DN change is that all historical data (performance, alarms, notifications etc.) related to this cell, using the old DN, become useless unless also a remapping (e.g., relate the old DN with the new DN) table is provided to the management system. Additionally, another problem with changing the DN is that all management scripts and commands operating on the cell need to be updated with the new DN.

The DN also changes at rehoming in UMTS and GSM.

This problem is not specific to a cell under management but also applies to any managed entity (e.g. a managed network function) that is moved from one network, sub-network, managed element to another.

Furthermore, changing the logical deployment between an aggregated view (where one Managed Element is used to represent all three functions) and a disaggregated view with one Managed Element for each function will be costly for the same reason as for rehoming of cells—the addressing of all CM data in these functions will be modified when moved in under a common Managed Element or moved out to two or three different Managed Elements—even though the actual hardware used stays the same and the functional responsibility of each hardware component remains the same.

Certain aspects of the present disclosure and their embodiments may provide solutions to these or other challenges.

In order to achieve the objective, i.e., to ensure that any managed entity can be moved from one network, subnetwork, or managed element to another without loss of reference to historical data or that all scripts and commands operating on the managed entity has to be updated (e.g., that a gNB-DU can be moved to another gNB-CU without loss of reference to historical data or update of all commands and scripts operating on the particular gNB-DU) or for rehoming in UMTS and GSM, the solution presented herein proposes:
Introducing an additional DN naming for the NRM that allows for example gNB-DU cells to be globally and unambiguously identified without being related to a parent object that may change identity, to be used in parallel with the currently used naming scheme. The choice of Managed Object Classes for which to enable this global naming mechanism for is done at design time by the node vendor.
For vendors of management systems to use this additional naming rule when storing references to objects that have this naming feature, and to use the closest parent object with UUID as the global root when refereeing to objects that are not designed to use the new DN naming scheme.

In view of the embodiments above, e.g., those presented in the Summary, the present disclosure generally includes the following embodiments, e.g., which may address one or more of the issues disclosed herein.

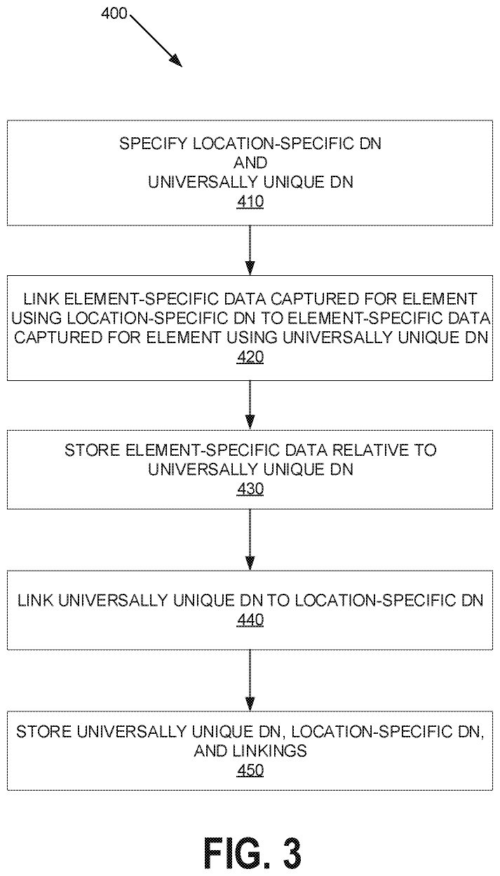

FIG. 3 depicts a method 400 in accordance with particular embodiments. The method 400 is performed by a resource management system to maintain an association between element-specific data and the corresponding element within a network independent of a physical or logical location of the element within the network to seamlessly accommodate changing locations of the element. For each of a plurality of elements in the network, the method comprises specifying, storing, and linking steps. In particular, the method 400 comprises specifying at least two Distinguished Names (DNs) comprising a location-specific DN and a universally unique DN as a reference for the corresponding element (block 410). The location-specific DN is defined by a physical or logical location of the corresponding element within the network, and the universally unique DN comprises a Universal Unique Identifier (UUID) that is independent of the physical or logical location of the corresponding element within the network. The method 400 further comprises linking the element-specific data captured for an element using the corresponding location-specific DN to the element-specific data captured for the element using the corresponding universally unique DN (block 420), and storing element-specific data relative to the universally unique DN in memory of the resource management system (block 430). The method 400 further comprises linking the universally unique DN to the corresponding location-specific DN to enable the resource management system to access the element-specific data stored relative to the universally unique DN using the location-specific DN (block 440), and storing the identified location-specific DN, the universally unique DN, and the corresponding linking in the memory of the resource management system (block 450). As used herein, an element within a network represents any logical function and/or physical device within the network that facilitates the operations of the network and is assigned a location-specific address defining the physical and/or logical location within the network. Further, as used herein, the resource management system represents one or more devices and/or nodes within the network that manages and/or oversees the resources used to execute and/or implement the various network operations.

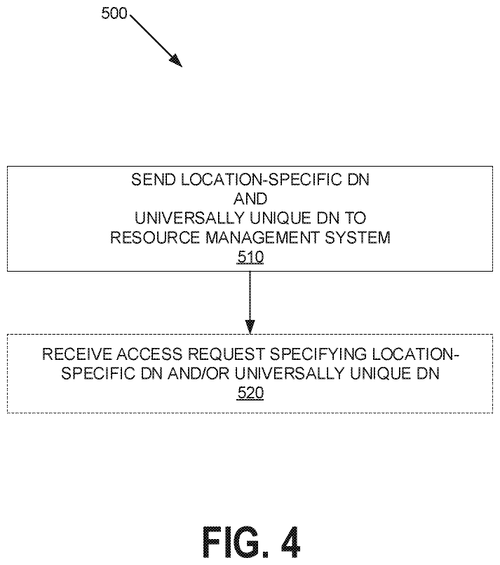

FIG. 4 depicts a method 500 in accordance with particular embodiments. The method 500 is performed by a managed element in a network. The method 500 comprises sending a notification to a resource management system in the network, the notification identifying a location-specific Distinguished Name (DN) and the universally unique DN for the managed element in the network at least each time the location-specific DN changes (block 510). In some embodiments, the method 500 further comprises the managed element receiving an access request, where the received access request specifies the location-specific DN and/or the universally unique DN for the managed element (block 520). The location-specific DN is defined by a physical or logical location of the corresponding element within the network, and the universally unique DN comprises a Universal Unique Identifier (UUID) that is independent of the physical or logical location of the corresponding element within the network.

Note that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

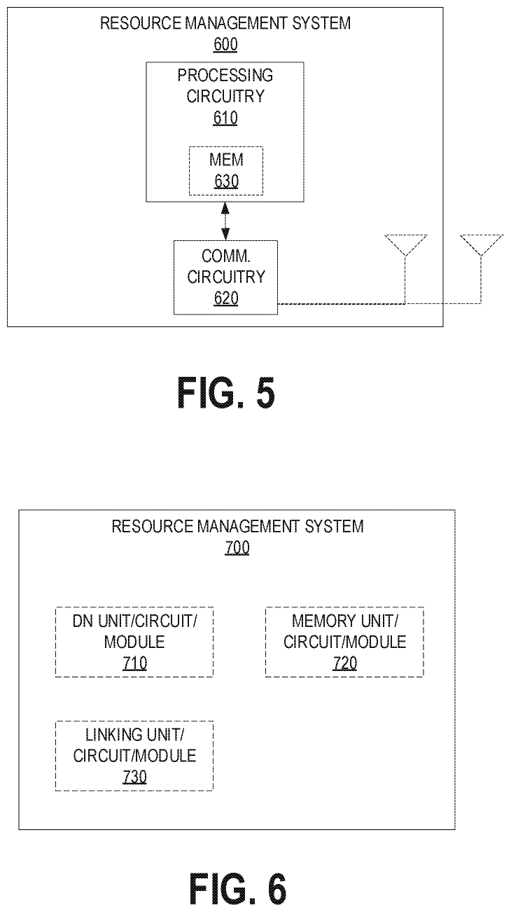

FIG. 5 for example illustrates a resource management system 600 as implemented in accordance with one or more embodiments. As shown, the resource management system 600 includes processing circuitry 610 and communication circuitry 620. The communication circuitry 620 (e.g., radio circuitry) is configured to transmit and/or receive information to and/or from one or more other nodes and/or devices in the network, e.g., via any communication technology. Such communication may occur via a wired connection or a wireless connection, e.g., via one or more antennas that are either internal or external to the resource management system 600. The processing circuitry 610 is configured to perform processing described above, e.g., according to the method in FIG. 3, such as by executing instructions stored in memory 630. The processing circuitry 610 in this regard may implement certain functional means, units, or modules.

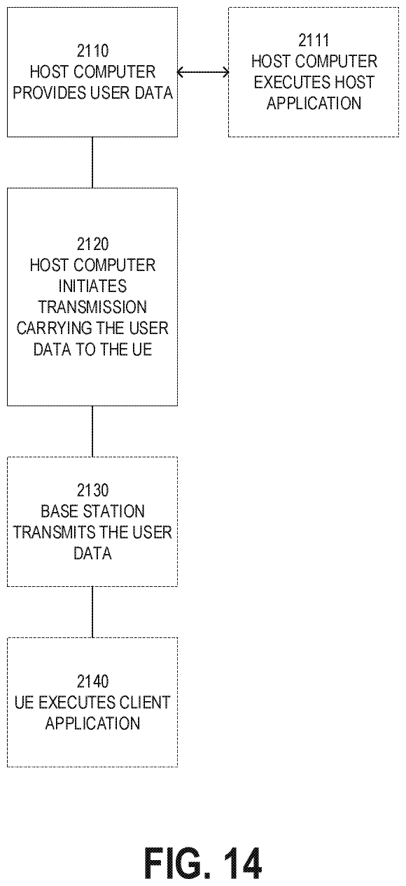

FIG. 6 illustrates a schematic block diagram of another resource management system 700 in a network according to still other embodiments (for example, the network shown in FIG. 14). As shown, the resource management system 700 implements various functional means, units, or modules, e.g., via the processing circuitry 710 in FIG. 5 and/or via software code. These functional means, units, or modules, e.g., for implementing the method(s) herein, include for instance: DN unit/circuit/module 710, memory unit/circuit/module 720, and linking unit/circuit/module 730. It will be appreciated that each one of these units may be implemented as a unit, as a circuit, or as a module. DN unit/circuit/module 710 is configured to specify at least two Distinguished Names (DNs) comprising a location-specific DN and a universally unique DN as a reference for the corresponding element. The location-specific DN is defined by a physical or logical location of the corresponding element within the network and the universally unique DN comprises a Universal Unique Identifier (UUID) that is independent of the physical or logical location of the corresponding element within the network. The linking unit/circuit/module 730 is configured to link element-specific data captured for an element using the corresponding location-specific DN to the element-specific data captured for the element using the corresponding universally unique DN. The memory unit/circuit/module 720 is configured to store element-specific data captured for a corresponding element relative to the universally unique DN in memory of the resource management system. The linking unit/circuit/module 730 is further configured to link the universally unique DN to the corresponding location-specific DN to enable the resource management system to access the element-specific data stored relative to the universally unique DN using the location-specific DN. The memory unit/circuit/module 720 is further configured to store the identified location-specific DN, the universally unique DN, and the corresponding linking in the memory of the resource management system.

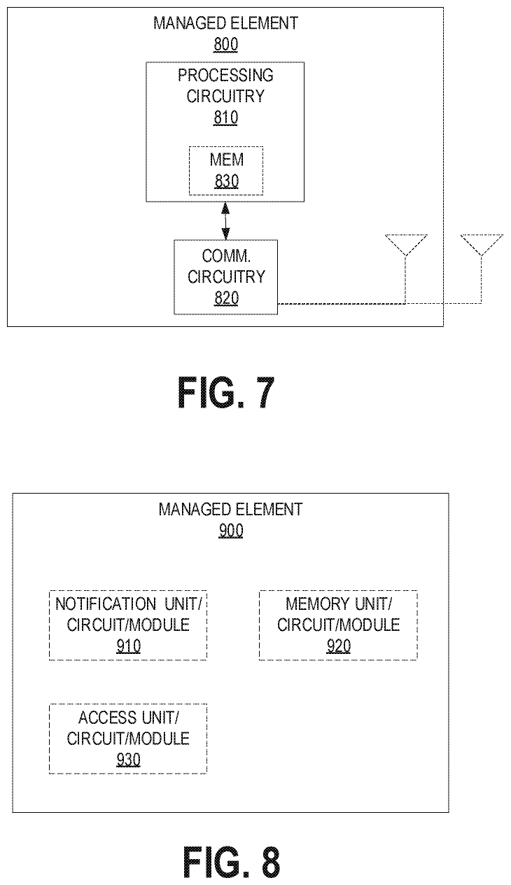

FIG. 7 for example illustrates a managed element 800 as implemented in accordance with one or more embodiments. As shown, the managed element 800 includes processing circuitry 810 and communication circuitry 820. The communication circuitry 820 (e.g., radio circuitry) is configured to transmit and/or receive information to and/or from one or more other nodes and/or devices in the network, e.g., via any communication technology. Such communication may occur via a wired connection or a wireless connection, e.g., via one or more antennas that are either internal or external to the managed element 800. The processing circuitry 810 is configured to perform processing described above, e.g., according to the method in FIG. 4, such as by executing instructions stored in memory 830. The processing circuitry 810 in this regard may implement certain functional means, units, or modules.

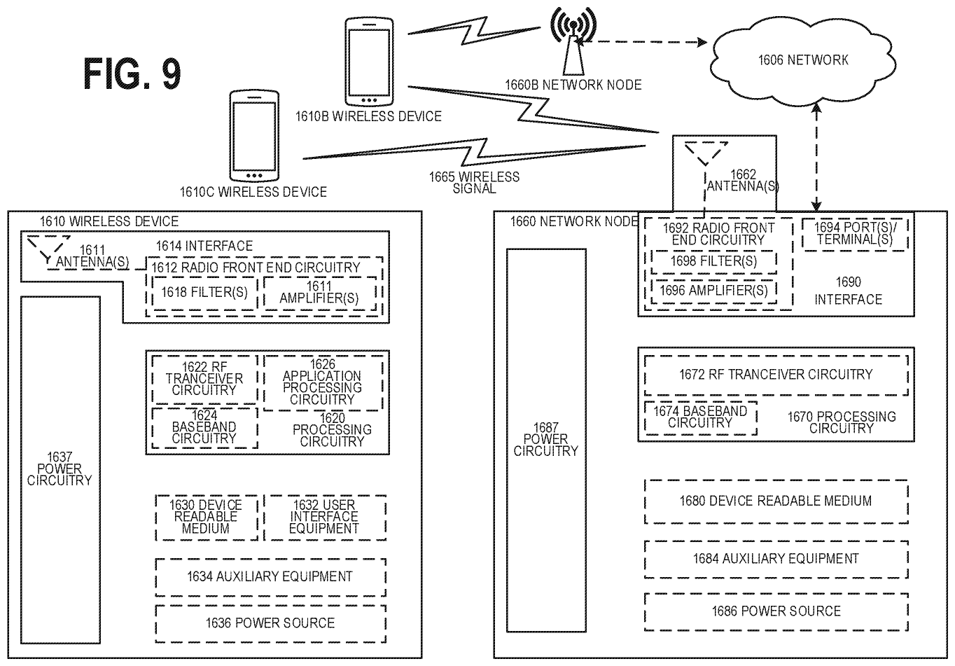

FIG. 8 illustrates a schematic block diagram of another managed element 900 in a network according to still other embodiments (for example, the network shown in FIG. 9). As shown, the managed element 900 implements various functional means, units, or modules, e.g., via the processing circuitry 810 in FIG. 7 and/or via software code. These functional means, units, or modules, e.g., for implementing the method(s) herein, include for instance: notification unit/circuit/module 910, memory unit/circuit/module 920, and access unit/circuit/module 930. It will be appreciated that each one of these units may be implemented as a unit, as a circuit, or as a module. Notification unit/circuit/module 910 is configured to send a notification to a resource management system in the network, where the notification identifies a location-specific DN and a universally unique DN for the managed element at least each time the location-specific DN changes. The location-specific DN is defined by a physical or logical location of the corresponding element within the network and the universally unique DN comprises a Universal Unique Identifier (UUID) that is independent of the physical or logical location of the corresponding element within the network. The optional access unit/circuit/module 930 is configured to receive an access request, where the received access request specifies the location-specific DN and/or the universally unique DN for the element. As such, the managed element 900 is configured to accept two different DNs for the same configuration item. The memory unit/circuit/module 920 is configured to store the location-specific ON and the universally unique DN.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or network types for illustrative purposes, but the embodiments are similarly applicable in other contexts and/or network types not explicitly described. It will be appreciated that the solution presented herein is applicable to any network, including but not limited to a wireless network.

In the following, the solution presented herein is illustrated by exemplary embodiments. It should be noted that these embodiments are not mutually exclusive. Components from one embodiment may be tacitly assumed to be present in another embodiment and it will be obvious to a person skilled in the art how those components may be used in the other exemplary embodiments.

Embodiments below will be exemplified with both LTE and 5G as the communications network but are applicable to GSM, UMTS as well as any communications network.

In a first embodiment the objective is achieved by introducing a Network Resource Model (NRM) having a base tree of smaller models, where each smaller model (a sub-tree in its own right) will have a local root with globally unique identity, and thus it can be used as the global root for elements within the local tree. This allows the base tree to be restructured. As the path of the base tree is no longer used for referencing the content of the sub-trees the restructuring operation is cheap as it does not affect stored references to the sub-trees.

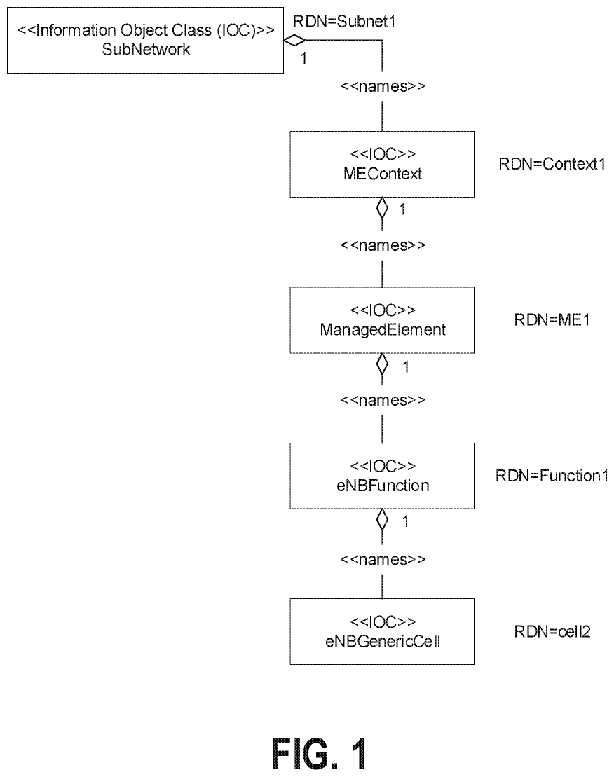

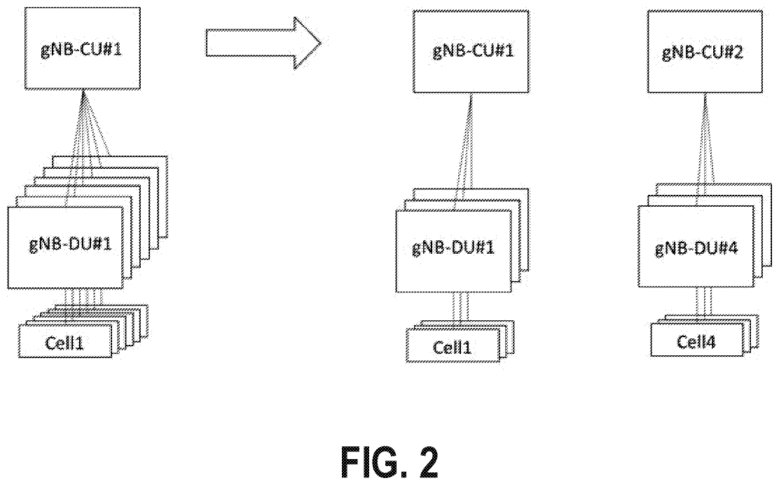

As an example in order to address the objective when cells are rehomed it is proposed to introduce, for the Network Resource Model, a new naming attribute for the eNBGenericCell, tentatively called UUID. The value of this new naming attribute is a Universally Unique Identifier as per IETF RFC 4122. For an eNBGenericCell in a Network Resource Model as depicted in FIG. 1, the eNBGenericCell will now have two valid fully distinguished names (DNs):
DC=Company.com,SubNetwork=Subnet1, MeContext=Context1, ManagedElement=ME1, eNBFunction=Function1, eNBGenericCell=Cell2 TS 32.300, Annex B, second interpretation. This is referred to as the “classical DN”.
eNBGenericCell.UUID=<TheUUIDValue>TS 32.300, Annex B, second interpretation, example 2 where the attribute name is not “Id”. This format of the address is referred to as the “UUID based DN”. The whole text string “<TheUUIDValue>” in this example is a placeholder for an actual UUID value as per FRC 4122.

Locally, inside the node, the eNBGenericCell will now also have two valid local distinguished names (LDNs):
Managed Element=ME1, eNBFunction=Function1, eNBGenericCell=Cell2 TS 32.300, Annex B, second interpretation. This is referred to as the “classical LDN”.
eNBGenericCell.UUID=<TheUUIDValue>TS 32.300, Annex B, second interpretation, example 2 where the attribute name is not “Id”. This format of the address is referred to as the “UUID based DN” as it still also is globally unique. The whole text string “<TheUUIDValue>” in this example is a placeholder for an actual UUID value as per FRC 4122.

In a second embodiment, in order to address the objective, the management system will, when encountering a network resource model consisting of a base tree of smaller models, where each smaller model (a sub-tree in its own right) has a local root with globally unique identity, utilize a dual naming possibility and record the translation between the classical DN and the globally unique identity based DN in a mapping table.

As an example when the management system encounters a model description of the eNBGenericCell, the management system utilizes the dual naming possibility and records the translation between the classical DN and the UUID based DN in a mapping table (see example in embodiment 1). This mapping table is used as follows;
In all future communication from the node (the Managed Element) to the management system, this mapping table is used to map from the classical DN to the UUID based DN if the node happens to use the classical DN. The management system will then store all data about Cell2 using the UUID based DN.
In all future communications from the management system to the node, the management system will use this mapping table to resolve a UUID based DN back to a classical DN in order to find the connectivity address and method to connect to the node.

The management system may, when having established a connection to the node, choose to use the classical DN or the UUID based DN when operating on the content of the node, as both naming schemes must be valid on the node.

In a concrete example, when the operator managing the radio access network has decided to move (rehome) the eNBGenericCell from Node A to Node B:
Node A has the LDN SubNetwork=Subnet1, MeContext=Context1, ManagedElement=ME1
Node B has the LDN SubNetwork=Subnet1, MeContext=Context4, ManagedElement=ME3

When the management system is notified about configuration changes in both Node A (data is removed) and Node B (data is added), it becomes clear that Cell2 with the UUID based DN now appears under the DN of Node B. As a result, the management system updates the mapping table accordingly, all stored historical data based on the UUID based DN for Cell2 is still correct and the management system can find the addressing info needed to connect to the node and operate on Cell2.

In another example relating both to embodiments 1 and 2, New cells case:
Create new cell instance using two DNs, i.e., the classical DN (e.g., DN-1) and the proposed new UUID based DN (e.g., DN-0).
When the node generates events or notifications about a cell instance, the events and notifications would bear one classical DN-1 and one UUID based DN-0. After the cell is rehomed, the node would generate events or notifications about the cell instance bearing DN-0 and DN-2 (note that the DN-1 have changed after rehoming).
The management system can group (or relate) events and notifications that bear the same UUID based DN, regardless if the cells are rehomed or not.

For existing cells (that do not bear the UUID based DNs):
Populate all existing cells with a UUID based DNs (e.g., DN-344). Management system would remember that the classical DN and the UUID based DN are both referring to the same cell instance (e.g., UUID based DN-344 is related to classical DN-17).
When the node generates events or notifications about a cell instance, the events and notifications would bear one classical DN (e.g., ON-17) and one UUID based DN (e.g., ON-344).
The management system can group (or relate) events and notifications that bear the UUID based DN-344 with historical events and notifications that bear the classical DN-17.

For both cases, the management system can issue operation requests using the cell's classical DN (i.e., DN-1, DN-2 or DN-17 of the example or the UUID based DN, i.e., DN-344 of the example. The advantage with using the UUID based DNs is that there is no need to update scripts and commands in the management system should the DU cells be rehomed one more time at a later stage. It will be appreciated that the events/notifications may be provided to the management system by the node and/or by a managed element (e.g., RAN) in the network at least each time the classical DN changes or upon request.

In yet another example related to embodiments 1 and 2 New DU Cell case:
Create new DU cell instance using two DNs, i.e. the classical DN (e.g., DN-1) and the proposed new UUID based DN (e.g., DN-0).
When the node generates events or notifications about the DU cell instance, the events and notifications would bear one classical DN-1 and one UUID based DN-0. After the cell is rehomed (moved to another CU), the node would generate events or notifications about the DU cell instance bearing DN-0 and DN-2 (note that the DN-1 have changed after rehoming).
The management system can group (or relate) events and notifications that bear the same UUID based DN, regardless of whether the cells are rehomed.

For all existing DU cells case (that do not initially bear the UUID based DNs):
Populate cell with a UUID based DN (e.g., DN-344). Management system would remember that the classical DN and the UUID based DN are both referring to the same DU cell instance (e.g., UUID based DN-344 is related to classical DN-17).
When the node generates events or notifications related to the DU cell instance, the events and notifications would bear one classical DN (e.g., DN-17) and the UUID based DN (e.g., DN-344).
The management system can group (or relate) events and notifications that bear the UUID based DN-344 with historical events and notifications that bear the classical DN-17.

For both cases, the management system can issue operation requests using the cell's classical DN (i.e., DN-1,DN-2 or DN-17 of the example or the UUID based DN, i.e., DN-0 or DN-344 of the examples. The advantage with using the UUID based DNs is that there is no need to update scripts and commands in the management system should the DU cells be rehomed one more time at a later stage. It will be appreciated that these events/notifications may be provided to the management system by the node and/or by a managed element (e.g., RAN) at least each time the classical DN changes or upon request.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 1606, network nodes 1660 and 1660b, and WDs 1610, 1610b, and 1610c. In practice, a wireless network may further include any additional elements suitable to support communication between wireless devices or between a wireless device and another communication device, such as a landline telephone, a service provider, or any other network node or end device. Of the illustrated components, network node 1660 and wireless device (WD) 1610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1660 and WD 1610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs), and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network. In FIG. 9, network node 1660 includes processing circuitry 1670, device readable medium 1680, interface 1690, auxiliary equipment 1684, power source 1686, power circuitry 1687, and antenna 1662. Although network node 1660 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1660 are depicted as single boxes located within a larger box, or nested within multiple boxes, in practice, a network node may comprise multiple different physical components that make up a single illustrated component (e.g., device readable medium 1680 may comprise multiple separate hard drives as well as multiple RAM modules).

Similarly, network node 1660 may be composed of multiple physically separate components (e.g., a NodeB component and a RNC component, or a BTS component and a BSC component, etc.), which may each have their own respective components. In certain scenarios in which network node 1660 comprises multiple separate components (e.g., BTS and BSC components), one or more of the separate components may be shared among several network nodes. For example, a single RNC may control multiple NodeB's. In such a scenario, each unique NodeB and RNC pair may in some instances be considered a single separate network node. In some embodiments, network node 1660 may be configured to support multiple radio access technologies (RATs). In such embodiments, some components may be duplicated (e.g., separate device readable medium 1680 for the different RATs) and some components may be reused (e.g., the same antenna 1662 may be shared by the RATs). Network node 1660 may also include multiple sets of the various illustrated components for different wireless technologies integrated into network node 1660, such as, for example, GSM, WCDMA, LTE, NR, WiFi, or Bluetooth wireless technologies. These wireless technologies may be integrated into the same or different chip or set of chips and other components within network node 1660.

Processing circuitry 1670 is configured to perform any determining, calculating, or similar operations (e.g., certain obtaining operations) described herein as being provided by a network node. These operations performed by processing circuitry 1670 may include processing information obtained by processing circuitry 1670 by, for example, converting the obtained information into other information, comparing the obtained information or converted information to information stored in the network node, and/or performing one or more operations based on the obtained information or converted information, and as a result of said processing making a determination.

Processing circuitry 1670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1660 components, such as device readable medium 1680, network node 1660 functionality. For example, processing circuitry 1670 may execute instructions stored in device readable medium 1680 or in memory within processing circuitry 1670. Such functionality may include providing any of the various wireless features, functions, or benefits discussed herein. In some embodiments, processing circuitry 1670 may include a system on a chip (SOC).

In some embodiments, processing circuitry 1670 may include one or more of radio frequency (RF) transceiver circuitry 1672 and baseband processing circuitry 1674. In some embodiments, radio frequency (RF) transceiver circuitry 1672 and baseband processing circuitry 1674 may be on separate chips (or sets of chips), boards, or units, such as radio units and digital units. In alternative embodiments, part or all of RF transceiver circuitry 1672 and baseband processing circuitry 1674 may be on the same chip or set of chips, boards, or units

In certain embodiments, some or all of the functionality described herein as being provided by a network node, base station, eNB or other such network device may be performed by processing circuitry 1670 executing instructions stored on device readable medium 1680 or memory within processing circuitry 1670. In alternative embodiments, some or all of the functionality may be provided by processing circuitry 1670 without executing instructions stored on a separate or discrete device readable medium, such as in a hard-wired manner. In any of those embodiments, whether executing instructions stored on a device readable storage medium or not, processing circuitry 1670 can be configured to perform the described functionality. The benefits provided by such functionality are not limited to processing circuitry 1670 alone or to other components of network node 1660, but are enjoyed by network node 1660 as a whole, and/or by end users and the wireless network generally.

Device readable medium 1680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1670. Device readable medium 1680 may store any suitable instructions, data or information, including a computer program, software, an application including one or more of logic, rules, code, tables, etc. and/or other instructions capable of being executed by processing circuitry 1670 and, utilized by network node 1660. Device readable medium 1680 may be used to store any calculations made by processing circuitry 1670 and/or any data received via interface 1690. In some embodiments, processing circuitry 1670 and device readable medium 1680 may be considered to be integrated.

Interface 1690 is used in the wired or wireless communication of signaling and/or data between network node 1660, network 1606, and/or WDs 1610. As illustrated, interface 1690 comprises port(s)/terminal(s) 1694 to send and receive data, for example to and from network 1606 over a wired connection. Interface 1690 also includes radio front end circuitry 1692 that may be coupled to, or in certain embodiments a part of, antenna 1662. Radio front end circuitry 1692 comprises filters 1698 and amplifiers 1696. Radio front end circuitry 1692 may be connected to antenna 1662 and processing circuitry 1670. Radio front end circuitry may be configured to condition signals communicated between antenna 1662 and processing circuitry 1670. Radio front end circuitry 1692 may receive digital data that is to be sent out to other network nodes or WDs via a wireless connection. Radio front end circuitry 1692 may convert the digital data into a radio signal having the appropriate channel and bandwidth parameters using a combination of filters 1698 and/or amplifiers 1696. The radio signal may then be transmitted via antenna 1662. Similarly, when receiving data, antenna 1662 may collect radio signals which are then converted into digital data by radio front end circuitry 1692. The digital data may be passed to processing circuitry 1670. In other embodiments, the interface may comprise different components and/or different combinations of components.

In certain alternative embodiments, network node 1660 may not include separate radio front end circuitry 1692; instead, processing circuitry 1670 may comprise radio front end circuitry and may be connected to antenna 1662 without separate radio front end circuitry 1692. Similarly, in some embodiments, all or some of RF transceiver circuitry 1672 may be considered a part of interface 1690. In still other embodiments, interface 1690 may include one or more ports or terminals 1694, radio front end circuitry 1692, and RF transceiver circuitry 1672, as part of a radio unit (not shown), and interface 1690 may communicate with baseband processing circuitry 1674, which is part of a digital unit (not shown).

Antenna 1662 may include one or more antennas, or antenna arrays, configured to send and/or receive wireless signals 1665. Antenna 1662 may be coupled to radio front end circuitry 1690 and may be any type of antenna capable of transmitting and receiving data and/or signals wirelessly. In some embodiments, antenna 1662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1662 may be separate from network node 1660 and may be connectable to network node 1660 through an interface or port.

Antenna 1662, interface 1690, and/or processing circuitry 1670 may be configured to perform any receiving operations and/or certain obtaining operations described herein as being performed by a network node. Any information, data and/or signals may be received from a wireless device, another network node and/or any other network equipment. Similarly, antenna 1662, interface 1690, and/or processing circuitry 1670 may be configured to perform any transmitting operations described herein as being performed by a network node. Any information, data and/or signals may be transmitted to a wireless device, another network node and/or any other network equipment.

Power circuitry 1687 may comprise, or be coupled to, power management circuitry and is configured to supply the components of network node 1660 with power for performing the functionality described herein. Power circuitry 1687 may receive power from power source 1686. Power source 1686 and/or power circuitry 1687 may be configured to provide power to the various components of network node 1660 in a form suitable for the respective components (e.g., at a voltage and current level needed for each respective component). Power source 1686 may either be included in, or external to, power circuitry 1687 and/or network node 1660. For example, network node 1660 may be connectable to an external power source (e.g., an electricity outlet) via an input circuitry or interface such as an electrical cable, whereby the external power source supplies power to power circuitry 1687. As a further example, power source 1686 may comprise a source of power in the form of a battery or battery pack which is connected to, or integrated in, power circuitry 1687. The battery may provide backup power should the external power source fail. Other types of power sources, such as photovoltaic devices, may also be used.

Alternative embodiments of network node 1660 may include additional components beyond those shown in FIG. 9 that may be responsible for providing certain aspects of the network node's functionality, including any of the functionality described herein and/or any functionality necessary to support the subject matter described herein. For example, network node 1660 may include user interface equipment to allow input of information into network node 1660 and to allow output of information from network node 1660. This may allow a user to perform diagnostic, maintenance, repair, and other administrative functions for network node 1660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1610 includes antenna 1611, interface 1614, processing circuitry 1620, device readable medium 1630, user interface equipment 1632, auxiliary equipment 1634, power source 1636 and power circuitry 1637. WD 1610 may include multiple sets of one or more of the illustrated components for different wireless technologies supported by WD 1610, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1610.

Antenna 1611 may include one or more antennas or antenna arrays, configured to send and/or receive wireless signals, and is connected to interface 1614. In certain alternative embodiments, antenna 1611 may be separate from WD 1610 and be connectable to WD 1610 through an interface or port. Antenna 1611, interface 1614, and/or processing circuitry 1620 may be configured to perform any receiving or transmitting operations described herein as being performed by a WD. Any information, data and/or signals may be received from a network node and/or another WD. In some embodiments, radio front end circuitry and/or antenna 1611 may be considered an interface.

As illustrated, interface 1614 comprises radio front end circuitry 1612 and antenna 1611. Radio front end circuitry 1612 comprise one or more filters 1618 and amplifiers 1616. Radio front end circuitry 1614 is connected to antenna 1611 and processing circuitry 1620, and is configured to condition signals communicated between antenna 1611 and processing circuitry 1620. Radio front end circuitry 1612 may be coupled to or a part of antenna 1611. In some embodiments, WD 1610 may not include separate radio front end circuitry 1612; rather, processing circuitry 1620 may comprise radio front end circuitry and may be connected to antenna 1611. Similarly, in some embodiments, some or all of RF transceiver circuitry 1622 may be considered a part of interface 1614. Radio front end circuitry 1612 may receive digital data that is to be sent out to other network nodes or WDs via a wireless connection. Radio front end circuitry 1612 may convert the digital data into a radio signal having the appropriate channel and bandwidth parameters using a combination of filters 1618 and/or amplifiers 1616. The radio signal may then be transmitted via antenna 1611. Similarly, when receiving data, antenna 1611 may collect radio signals which are then converted into digital data by radio front end circuitry 1612. The digital data may be passed to processing circuitry 1620. In other embodiments, the interface may comprise different components and/or different combinations of components.

Processing circuitry 1620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1610 components, such as device readable medium 1630, WD 1610 functionality. Such functionality may include providing any of the various wireless features or benefits discussed herein. For example, processing circuitry 1620 may execute instructions stored in device readable medium 1630 or in memory within processing circuitry 1620 to provide the functionality disclosed herein.

As illustrated, processing circuitry 1620 includes one or more of RF transceiver circuitry 1622, baseband processing circuitry 1624, and application processing circuitry 1626. In other embodiments, the processing circuitry may comprise different components and/or different combinations of components. In certain embodiments processing circuitry 1620 of WD 1610 may comprise a SOC. In some embodiments, RF transceiver circuitry 1622, baseband processing circuitry 1624, and application processing circuitry 1626 may be on separate chips or sets of chips. In alternative embodiments, part or all of baseband processing circuitry 1624 and application processing circuitry 1626 may be combined into one chip or set of chips, and RF transceiver circuitry 1622 may be on a separate chip or set of chips. In still alternative embodiments, part or all of RF transceiver circuitry 1622 and baseband processing circuitry 1624 may be on the same chip or set of chips, and application processing circuitry 1626 may be on a separate chip or set of chips. In yet other alternative embodiments, part or all of RF transceiver circuitry 1622, baseband processing circuitry 1624, and application processing circuitry 1626 may be combined in the same chip or set of chips. In some embodiments, RF transceiver circuitry 1622 may be a part of interface 1614. RF transceiver circuitry 1622 may condition RF signals for processing circuitry 1620.

In certain embodiments, some or all of the functionality described herein as being performed by a WD may be provided by processing circuitry 1620 executing instructions stored on device readable medium 1630, which in certain embodiments may be a computer-readable storage medium. In alternative embodiments, some or all of the functionality may be provided by processing circuitry 1620 without executing instructions stored on a separate or discrete device readable storage medium, such as in a hard-wired manner. In any of those particular embodiments, whether executing instructions stored on a device readable storage medium or not, processing circuitry 1620 can be configured to perform the described functionality. The benefits provided by such functionality are not limited to processing circuitry 1620 alone or to other components of WD 1610, but are enjoyed by WD 1610 as a whole, and/or by end users and the wireless network generally.

Processing circuitry 1620 may be configured to perform any determining, calculating, or similar operations (e.g., certain obtaining operations) described herein as being performed by a WD. These operations, as performed by processing circuitry 1620, may include processing information obtained by processing circuitry 1620 by, for example, converting the obtained information into other information, comparing the obtained information or converted information to information stored by WD 1610, and/or performing one or more operations based on the obtained information or converted information, and as a result of said processing making a determination.

Device readable medium 1630 may be operable to store a computer program, software, an application including one or more of logic, rules, code, tables, etc. and/or other instructions capable of being executed by processing circuitry 1620. Device readable medium 1630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1620. In some embodiments, processing circuitry 1620 and device readable medium 1630 may be considered to be integrated.

User interface equipment 1632 may provide components that allow for a human user to interact with WD 1610. Such interaction may be of many forms, such as visual, audial, tactile, etc. User interface equipment 1632 may be operable to produce output to the user and to allow the user to provide input to WD 1610. The type of interaction may vary depending on the type of user interface equipment 1632 installed in WD 1610. For example, if WD 1610 is a smart phone, the interaction may be via a touch screen; if WD 1610 is a smart meter, the interaction may be through a screen that provides usage (e.g., the number of gallons used) or a speaker that provides an audible alert (e.g., if smoke is detected). User interface equipment 1632 may include input interfaces, devices and circuits, and output interfaces, devices and circuits. User interface equipment 1632 is configured to allow input of information into WD 1610, and is connected to processing circuitry 1620 to allow processing circuitry 1620 to process the input information. User interface equipment 1632 may include, for example, a microphone, a proximity or other sensor, keys/buttons, a touch display, one or more cameras, a USB port, or other input circuitry. User interface equipment 1632 is also configured to allow output of information from WD 1610, and to allow processing circuitry 1620 to output information from WD 1610. User interface equipment 1632 may include, for example, a speaker, a display, vibrating circuitry, a USB port, a headphone interface, or other output circuitry. Using one or more input and output interfaces, devices, and circuits, of user interface equipment 1632, WD 1610 may communicate with end users and/or the wireless network, and allow them to benefit from the functionality described herein.

Auxiliary equipment 1634 is operable to provide more specific functionality which may not be generally performed by WDs. This may comprise specialized sensors for doing measurements for various purposes, interfaces for additional types of communication such as wired communications etc. The inclusion and type of components of auxiliary equipment 1634 may vary depending on the embodiment and/or scenario.

Power source 1636 may, in some embodiments, be in the form of a battery or battery pack. Other types of power sources, such as an external power source (e.g., an electricity outlet), photovoltaic devices or power cells, may also be used. WD 1610 may further comprise power circuitry 1637 for delivering power from power source 1636 to the various parts of WD 1610 which need power from power source 1636 to carry out any functionality described or indicated herein. Power circuitry 1637 may in certain embodiments comprise power management circuitry. Power circuitry 1637 may additionally or alternatively be operable to receive power from an external power source; in which case WD 1610 may be connectable to the external power source (such as an electricity Power circuitry 1637 may also in certain embodiments be operable to deliver power from an external power source to power source 1636. This may be, for example, for the charging of power source 1636. Power circuitry 1637 may perform any formatting, converting, or other modification to the power from power source 1636 to make the power suitable for the respective components of WD 1610 to which power is supplied.

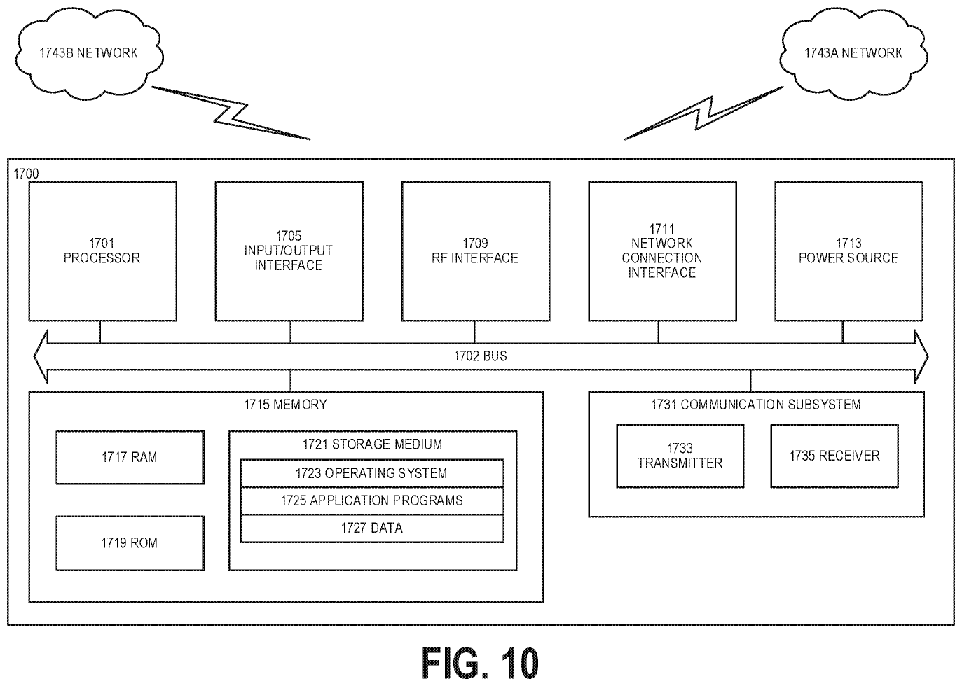

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1720 may be any UE identified by the 3^{rd} Generation Partnership Project (3GPP), including a NB-IoT UE, a machine type communication (MTC) UE, and/or an enhanced MTC (eMTC) UE. UE 1700, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1700 includes processing circuitry 1701 that is operatively coupled to input/output interface 1705, radio frequency (RF) interface 1709, network connection interface 1711, memory 1715 including random access memory (RAM) 1717, read-only memory (ROM) 1719, and storage medium 1721 or the like, communication subsystem 1731, power source 1733, and/or any other component, or any combination thereof. Storage medium 1721 includes operating system 1723, application program 1725, and data 1727. In other embodiments, storage medium 1721 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1701 may be configured to process computer instructions and data. Processing circuitry 1701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1701 may include two central processing units (CPUs). Data may be information in a form suitable for use by a computer.

In the depicted embodiment, input/output interface 1705 may be configured to provide a communication interface to an input device, output device, or input and output device. UE 1700 may be configured to use an output device via input/output interface 1705. An output device may use the same type of interface port as an input device. For example, a USB port may be used to provide input to and output from UE 1700. The output device may be a speaker, a sound card, a video card, a display, a monitor, a printer, an actuator, an emitter, a smartcard, another output device, or any combination thereof. UE 1700 may be configured to use an input device via input/output interface 1705 to allow a user to capture information into UE 1700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1709 may be configured to provide a communication interface to RF components such as a transmitter, a receiver, and an antenna. Network connection interface 1711 may be configured to provide a communication interface to network 1743a. Network 1743a may encompass wired and/or wireless networks such as a local-area network (LAN), a wide-area network (WAN), a computer network, a wireless network, a telecommunications network, another like network or any combination thereof. For example, network 1743a may comprise a Wi-Fi network. Network connection interface 1711 may be configured to include a receiver and a transmitter interface used to communicate with one or more other devices over a communication network according to one or more communication protocols, such as Ethernet, TCP/IP, SONET, ATM, or the like. Network connection interface 1711 may implement receiver and transmitter functionality appropriate to the communication network links (e.g., optical, electrical, and the like). The transmitter and receiver functions may share circuit components, software or firmware, or alternatively may be implemented separately.

RAM 1717 may be configured to interface via bus 1702 to processing circuitry 1701 to provide storage or caching of data or computer instructions during the execution of software programs such as the operating system, application programs, and device drivers. ROM 1719 may be configured to provide computer instructions or data to processing circuitry 1701. For example, ROM 1719 may be configured to store invariant low-level system code or data for basic system functions such as basic input and output (I/O), startup, or reception of keystrokes from a keyboard that are stored in a non-volatile memory. Storage medium 1721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1721 may be configured to include operating system 1723, application program 1725 such as a web browser application, a widget or gadget engine or another application, and data file 1727. Storage medium 1721 may store, for use by UE 1700, any of a variety of various operating systems or combinations of operating systems.

Storage medium 1721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1721 may allow UE 1700 to access computer-executable instructions, application programs or the like, stored on transitory or non-transitory memory media, to off-load data, or to upload data. An article of manufacture, such as one utilizing a communication system may be tangibly embodied in storage medium 1721, which may comprise a device readable medium.

In FIG. 10, processing circuitry 1701 may be configured to communicate with network 1743b using communication subsystem 1731. Network 1743a and network 1743b may be the same network or networks or different network or networks. Communication subsystem 1731 may be configured to include one or more transceivers used to communicate with network 1743b. For example, communication subsystem 1731 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1733 and/or receiver 1735 to implement transmitter or receiver functionality, respectively, appropriate to the RAN links (e.g., frequency allocations and the like). Further, transmitter 1733 and receiver 1735 of each transceiver may share circuit components, software or firmware, or alternatively may be implemented separately.

In the illustrated embodiment, the communication functions of communication subsystem 1731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1731 may include cellular communication, Wi-Fi communication, Bluetooth communication, and GPS communication. Network 1743b may encompass wired and/or wireless networks such as a local-area network (LAN), a wide-area network (WAN), a computer network, a wireless network, a telecommunications network, another like network or any combination thereof. For example, network 1743b may be a cellular network, a Wi-Fi network, and/or a near-field network. Power source 1713 may be configured to provide alternating current (AC) or direct current (DC) power to components of UE 1700.

The features, benefits and/or functions described herein may be implemented in one of the components of UE 1700 or partitioned across multiple components of UE 1700. Further, the features, benefits, and/or functions described herein may be implemented in any combination of hardware, software or firmware. In one example, communication subsystem 1731 may be configured to include any of the components described herein. Further, processing circuitry 1701 may be configured to communicate with any of such components over bus 1702. In another example, any of such components may be represented by program instructions stored in memory that when executed by processing circuitry 1701 perform the corresponding functions described herein. In another example, the functionality of any of such components may be partitioned between processing circuitry 1701 and communication subsystem 1731. In another example, the non-computationally intensive functions of any of such components may be implemented in software or firmware and the computationally intensive functions may be implemented in hardware.

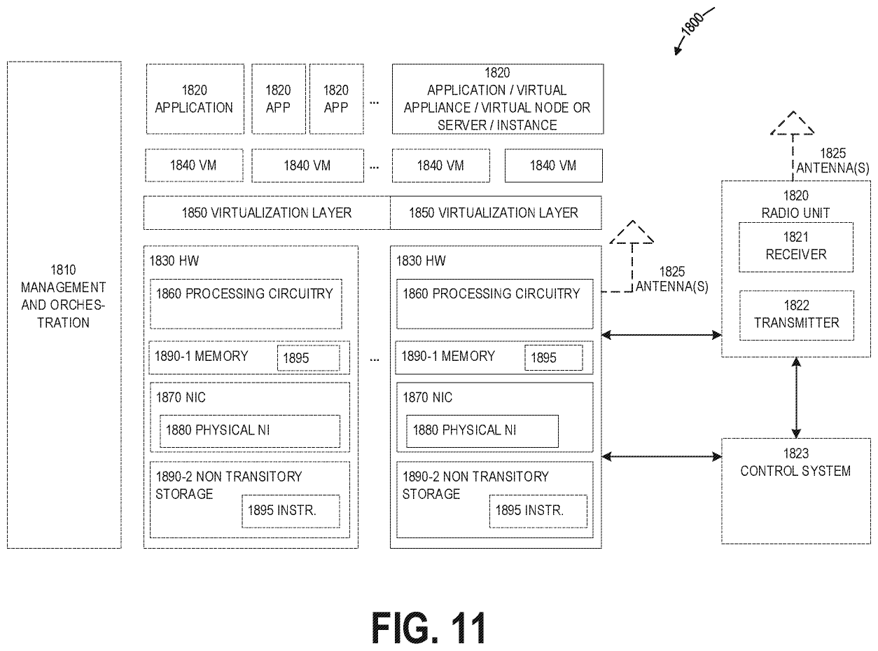

FIG. 11 is a schematic block diagram illustrating a virtualization environment 1800 in which functions implemented by some embodiments may be virtualized. In the present context, virtualizing means creating virtual versions of apparatuses or devices, which may include virtualizing hardware platforms, storage devices, and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1800 hosted by one or more of hardware nodes 1830. Further, in embodiments in which the virtual node is not a radio access node or does not require radio connectivity (e.g., a core network node), then the network node may be entirely virtualized.

The functions may be implemented by one or more applications 1820 (which may alternatively be called software instances, virtual appliances, network functions, virtual nodes, virtual network functions, etc.) operative to implement some of the features, functions, and/or benefits of some of the embodiments disclosed herein. Applications 1820 are run in virtualization environment 1800 which provides hardware 1830 comprising processing circuitry 1860 and memory 1890. Memory 1890 contains instructions 1895 executable by processing circuitry 1860 whereby application 1820 is operative to provide one or more of the features, benefits, and/or functions disclosed herein.

Virtualization environment 1800, comprises general-purpose or special-purpose network hardware devices 1830 comprising a set of one or more processors or processing circuitry 1860, which may be commercial off-the-shelf (COTS) processors, dedicated Application Specific Integrated Circuits (ASICs), or any other type of processing circuitry including digital or analog hardware components or special purpose processors. Each hardware device may comprise memory 1890-1 which may be non-persistent memory for temporarily storing instructions 1895 or software executed by processing circuitry 1860. Each hardware device may comprise one or more network interface controllers (NICs) 1870, also known as network interface cards, which include physical network interface 1880. Each hardware device may also include non-transitory, persistent, machine-readable storage media 1890-2 having stored therein software 1895 and/or instructions executable by processing circuitry 1860. Software 1895 may include any type of software including software for instantiating one or more virtualization layers 1850 (also referred to as hypervisors), software to execute virtual machines 1840 as well as software allowing it to execute functions, features and/or benefits described in relation with some embodiments described herein.

Virtual machines 1840, comprise virtual processing, virtual memory, virtual networking or interface and virtual storage, and may be run by a corresponding virtualization layer 1850 or hypervisor. Different embodiments of the instance of virtual appliance 1820 may be implemented on one or more of virtual machines 1840, and the implementations may be made in different ways.

During operation, processing circuitry 1860 executes software 1895 to instantiate the hypervisor or virtualization layer 1850, which may sometimes be referred to as a virtual machine monitor (VMM). Virtualization layer 1850 may present a virtual operating platform that appears like networking hardware to virtual machine 1840.

As shown in FIG. 11, hardware 1830 may be a standalone network node with generic or specific components. Hardware 1830 may comprise antenna 18225 and may implement some functions via virtualization. Alternatively, hardware 1830 may be part of a larger cluster of hardware (e.g. such as in a data center or customer premise equipment (CPE)) where many hardware nodes work together and are managed via management and orchestration (MAN©) 1810, which, among others, oversees lifecycle management of applications 1820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1840 may be a software implementation of a physical machine that runs programs as if they were executing on a physical, non-virtualized machine. Each of virtual machines 1840, and that part of hardware 1830 that executes that virtual machine, be it hardware dedicated to that virtual machine and/or hardware shared by that virtual machine with others of the virtual machines 1840, forms a separate virtual network elements (VNE).

Still in the context of NFV, Virtual Network Function (VNF) is responsible for handling specific network functions that run in one or more virtual machines 1840 on top of hardware networking infrastructure 1830 and corresponds to application 1820 in FIG. 11.

In some embodiments, one or more radio units 1820 that each include one or more transmitters 1822 and one or more receivers 1821 may be coupled to one or more antennas 1825. Radio units 1820 may communicate directly with hardware nodes 1830 via one or more appropriate network interfaces and may be used in combination with the virtual components to provide a virtual node with radio capabilities, such as a radio access node or a base station.

In some embodiments, some signaling can be effected with the use of control system 1823 which may alternatively be used for communication between the hardware nodes 1830 and radio units 1820.

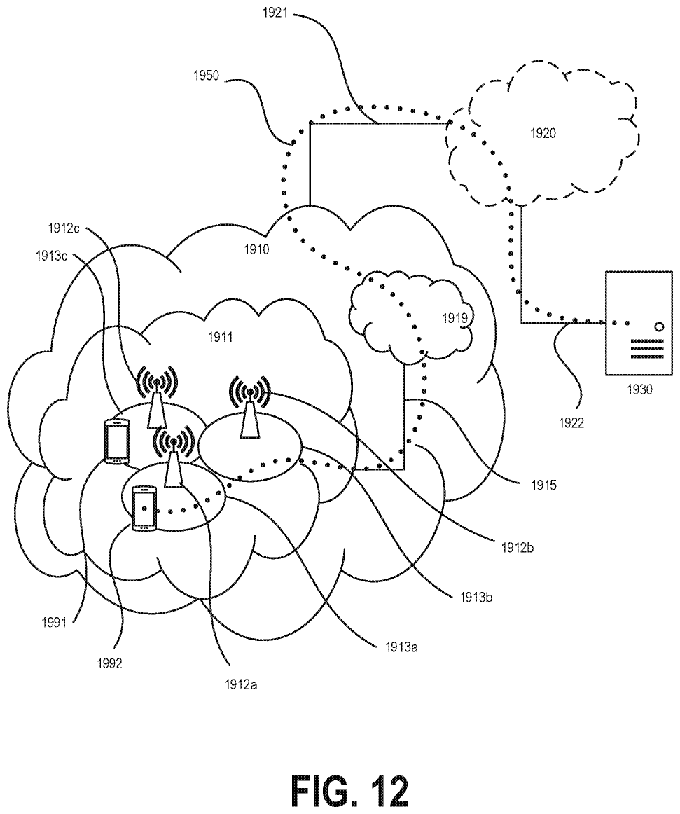

FIG. 12 illustrates a telecommunication network connected via an intermediate network to a host computer in accordance with some embodiments. In particular, with reference to FIG. 12, in accordance with an embodiment, a communication system includes telecommunication network 1910, such as a 3GPP-type cellular network, which comprises access network 1911, such as a radio access network, and core network 1914. Access network 1911 comprises a plurality of base stations 1912a, 1912b, 1912c, such as NBs, eNBs, gNBs or other types of wireless access points, each defining a corresponding coverage area 1913a, 1913b, 1913c. Each base station 1912a, 1912b, 1912c is connectable to core network 1914 over a wired or wireless connection 1915. A first UE 1991 located in coverage area 1913c is configured to wirelessly connect to, or be paged by, the corresponding base station 1912c. A second UE 1992 in coverage area 1913a is wirelessly connectable to the corresponding base station 1912a. While a plurality of UEs 1991, 1992 are illustrated in this example, the disclosed embodiments are equally applicable to a situation where a sole UE is in the coverage area or where a sole UE is connecting to the corresponding base station 1912.

Telecommunication network 1910 is itself connected to host computer 1930, which may be embodied in the hardware and/or software of a standalone server, a cloud-implemented server, a distributed server, or as processing resources in a server farm. Host computer 1930 may be under the ownership or control of a service provider, or may be operated by the service provider or on behalf of the service provider. Connections 1921 and 1922 between telecommunication network 1910 and host computer 1930 may extend directly from core network 1914 to host computer 1930 or may go via an optional intermediate network 1920. Intermediate network 1920 may be one of, or a combination of more than one of, a public, private or hosted network; intermediate network 1920, if any, may be a backbone network or the Internet; in particular, intermediate network 1920 may comprise two or more sub-networks (not shown).

The communication system of FIG. 12 as a whole enables connectivity between the connected UEs 1991, 1992 and host computer 1930. The connectivity may be described as an over-the-top (OTT) connection 1950. Host computer 1930 and the connected UEs 1991, 1992 are configured to communicate data and/or signaling via OTT connection 1950, using access network 1911, core network 1914, any intermediate network 1920 and possible further infrastructure (not shown) as intermediaries. OTT connection 1950 may be transparent in the sense that the participating communication devices through which OTT connection 1950 passes are unaware of routing of uplink and downlink communications. For example, base station 1912 may not or need not be informed about the past routing of an incoming downlink communication with data originating from host computer 1930 to be forwarded (e.g., handed over) to a connected UE 1991. Similarly, base station 1912 need not be aware of the future routing of an outgoing uplink communication originating from the UE 1991 towards the host computer 1930.

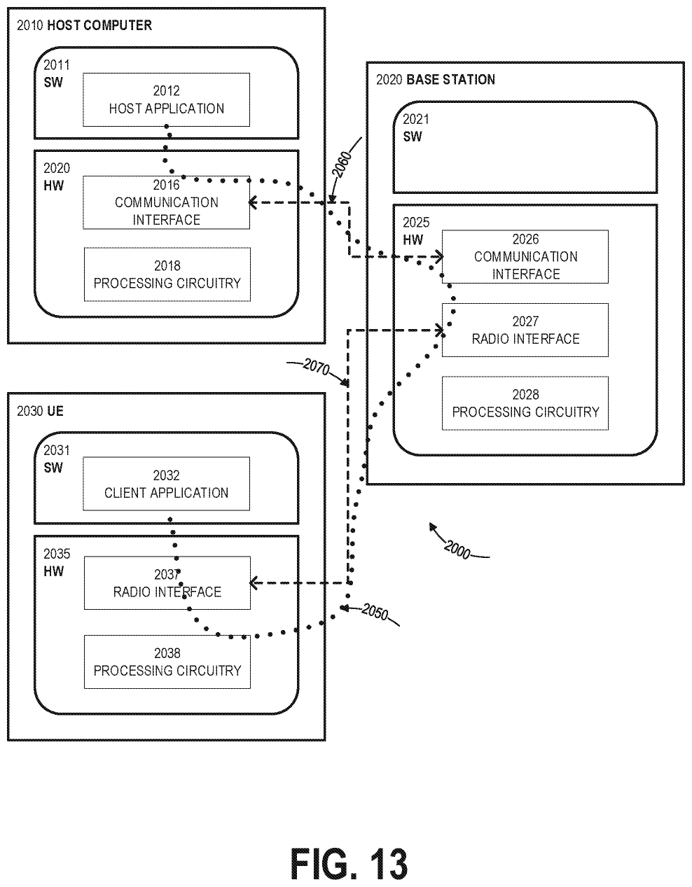

Example implementations, in accordance with an embodiment, of the UE, base station and host computer discussed in the preceding paragraphs will now be described with reference to FIG. 13. FIG. 13 illustrates host computer communicating via a base station with a user equipment over a partially wireless connection in accordance with some embodiments In communication system 2000, host computer 2010 comprises hardware 2015 including communication interface 2016 configured to set up and maintain a wired or wireless connection with an interface of a different communication device of communication system 2000. Host computer 2010 further comprises processing circuitry 2018, which may have storage and/or processing capabilities. In particular, processing circuitry 2018 may comprise one or more programmable processors, application-specific integrated circuits, field programmable gate arrays or combinations of these (not shown) adapted to execute instructions. Host computer 2010 further comprises software 2011, which is stored in or accessible by host computer 2010 and executable by processing circuitry 2018. Software 2011 includes host application 2012. Host application 2012 may be operable to provide a service to a remote user, such as UE 2030 connecting via OTT connection 2050 terminating at UE 2030 and host computer 2010. In providing the service to the remote user, host application 2012 may provide user data which is transmitted using OTT connection 2050.

Communication system 2000 further includes base station 2020 provided in a telecommunication system and comprising hardware 2025 enabling it to communicate with host computer 2010 and with UE 2030. Hardware 2025 may include communication interface 2026 for setting up and maintaining a wired or wireless connection with an interface of a different communication device of communication system 2000, as well as radio interface 2027 for setting up and maintaining at least wireless connection 2070 with UE 2030 located in a coverage area (not shown in FIG. 13) served by base station 2020. Communication interface 2026 may be configured to facilitate connection 2060 to host computer 2010. Connection 2060 may be direct or it may pass through a core network (not shown in FIG. 13) of the telecommunication system and/or through one or more intermediate networks outside the telecommunication system. In the embodiment shown, hardware 2025 of base station 2020 further includes processing circuitry 2028, which may comprise one or more programmable processors, application-specific integrated circuits, field programmable gate arrays or combinations of these (not shown) adapted to execute instructions. Base station 2020 further has software 2021 stored internally or accessible via an external connection.

Communication system 2000 further includes UE 2030 already referred to. Its hardware 2035 may include radio interface 2037 configured to set up and maintain wireless connection 2070 with a base station serving a coverage area in which UE 2030 is currently located. Hardware 2035 of UE 2030 further includes processing circuitry 2038, which may comprise one or more programmable processors, application-specific integrated circuits, field programmable gate arrays or combinations of these (not shown) adapted to execute instructions. UE 2030 further comprises software 2031, which is stored in or accessible by UE 2030 and executable by processing circuitry 2038. Software 2031 includes client application 2032. Client application 2032 may be operable to provide a service to a human or non-human user via UE 2030, with the support of host computer 2010. In host computer 2010, an executing host application 2012 may communicate with the executing client application 2032 via OTT connection 2050 terminating at UE 2030 and host computer 2010. In providing the service to the user, client application 2032 may receive request data from host application 2012 and provide user data in response to the request data. OTT connection 2050 may transfer both the request data and the user data. Client application 2032 may interact with the user to generate the user data that it provides.

It is noted that host computer 2010, base station 2020 and UE 2030 illustrated in FIG. 13 may be similar or identical to host computer 2030, one of base stations 2012a, 2012b, 2012c and one of UEs 2091, 2092 of FIG. 13, respectively. This is to say, the inner workings of these entities may be as shown in FIG. 13 and independently, the surrounding network topology may be that of FIG. 13.

In FIG. 13, OTT connection 2050 has been drawn abstractly to illustrate the communication between host computer 2010 and UE 2030 via base station 2020, without explicit reference to any intermediary devices and the precise routing of messages via these devices. Network infrastructure may determine the routing, which it may be configured to hide from UE 2030 or from the service provider operating host computer 2010, or both. While OTT connection 2050 is active, the network infrastructure may further take decisions by which it dynamically changes the routing (e.g., on the basis of load balancing consideration or reconfiguration of the network).

Wireless connection 2070 between UE 2030 and base station 2020 is in accordance with the teachings of the embodiments described throughout this disclosure. One or more of the various embodiments improve the performance of OTT services provided to UE 2030 using OTT connection 2050, in which wireless connection 2070 forms the last segment.

A measurement procedure may be provided for the purpose of monitoring data rate, latency and other factors on which the one or more embodiments improve. There may further be an optional network functionality for reconfiguring OTT connection 2050 between host computer 2010 and UE 2030, in response to variations in the measurement results. The measurement procedure and/or the network functionality for reconfiguring OTT connection 2050 may be implemented in software 2011 and hardware 2015 of host computer 2010 or in software 2031 and hardware 2035 of UE 2030, or both. In embodiments, sensors (not shown) may be deployed in or in association with communication devices through which OTT connection 2050 passes; the sensors may participate in the measurement procedure by supplying values of the monitored quantities exemplified above, or by supplying values of other physical quantities from which software 2011, 2031 may compute or estimate the monitored quantities. The reconfiguring of OTT connection 2050 may include message format, retransmission settings, preferred routing etc.; the reconfiguring need not affect base station 2020, and it may be unknown or imperceptible to base station 2020. Such procedures and functionalities may be known and practiced in the art. In certain embodiments, measurements may involve proprietary UE signaling facilitating host computer 2010′s measurements of throughput, propagation times, latency and the like. The measurements may be implemented in that software 2011 and 2031 causes messages to be transmitted, in particular empty or ‘dummy’ messages, using OTT connection 2050 while it monitors propagation times, errors etc.

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 2110, the host computer provides user data. In substep 2111 (which may be optional) of step 2110, the host computer provides the user data by executing a host application. In step 2120, the host computer initiates a transmission carrying the user data to the UE. In step 2130 (which may be optional), the base station transmits to the UE the user data which was carried in the transmission that the host computer initiated, in accordance with the teachings of the embodiments described throughout this disclosure. In step 2140 (which may also be optional), the UE executes a client application associated with the host application executed by the host computer.

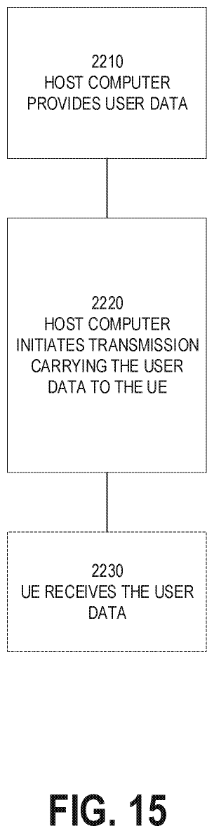

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 2210 of the method, the host computer provides user data. In an optional substep (not shown) the host computer provides the user data by executing a host application. In step 2220, the host computer initiates a transmission carrying the user data to the UE. The transmission may pass via the base station, in accordance with the teachings of the embodiments described throughout this disclosure. In step 2230 (which may be optional), the UE receives the user data carried in the transmission.

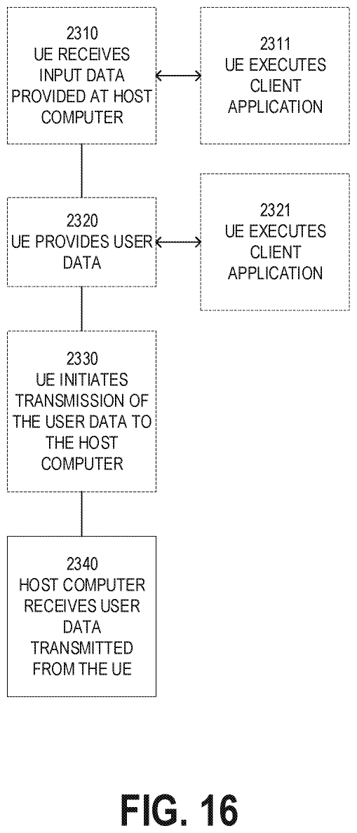

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 2310 (which may be optional), the UE receives input data provided by the host computer. Additionally or alternatively, in step 2320, the UE provides user data. In substep 2321 (which may be optional) of step 2320, the UE provides the user data by executing a client application. In substep 2311 (which may be optional) of step 2310, the UE executes a client application which provides the user data in reaction to the received input data provided by the host computer. In providing the user data, the executed client application may further consider user input received from the user. Regardless of the specific manner in which the user data was provided, the UE initiates, in substep 2330 (which may be optional), transmission of the user data to the host computer. In step 2340 of the method, the host computer receives the user data transmitted from the UE, in accordance with the teachings of the embodiments described throughout this disclosure.

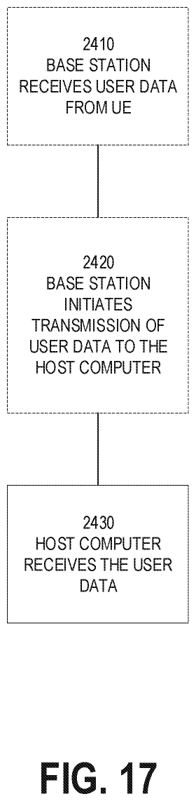

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 2410 (which may be optional), in accordance with the teachings of the embodiments described throughout this disclosure, the base station receives user data from the UE. In step 2420 (which may be optional), the base station initiates transmission of the received user data to the host computer. In step 2430 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

### Group A Embodiments

1. A method performed by a resource management system to maintain an association between element-specific data and the corresponding element within a network independent of a physical or logical location of the element within the network to seamlessly accommodate changing locations of the element, the method comprising, for each of a plurality of elements in the network:
   specifying at least two Distinguished Names (DNs) comprising a location-specific DN and a universally unique DN as references for the corresponding element, wherein the location-specific DN is defined by a physical or logical location of the corresponding element within the network and wherein the universally unique DN comprises a Universal Unique Identifier (UUID) that is independent of the physical or logical location of the corresponding element within the network;
   linking element-specific data captured using the location-specific DN for the corresponding element to element-specific data captured using the universally unique DN for the corresponding element;
   storing the element-specific data captured for a corresponding element relative to the universally unique DN in memory of the resource management system;
   linking the universally unique DN for the corresponding element to the location-specific DN for the corresponding element to enable the resource management system to access the element-specific data stored relative to the universally unique DN using the location-specific DN; and
   storing the identified location-specific DN, the universally unique DN, and the corresponding linkings in the memory of the resource management system.
2. The method of embodiment 1 further comprising:
   responsive to information indicating a new physical or logical location of one of the plurality of elements, changing the corresponding location-specific DN to determine an updated location-specific DN;
   linking the stored universally unique DN to the updated location-specific DN using a revised linking; and
   replacing the stored location-specific DN and the stored linking with the updated location-specific DN and the revised linking, respectively.
3. The method of any of embodiments 1-2 wherein:
   at least one of the plurality of elements comprises a cell within the network; and the location-specific DN comprises a DN representing:
      a generic cell;
      a generic Radio Access Network (RAN) node function; and
      a managed element.
4. The method of any of embodiments 1-2 wherein:
   at least one of the plurality of elements comprises a cell within the network; and the location-specific DN comprises a DN representing:
      a generic cell;
      a generic Radio Access Network (RAN) node function;
      a managed element;
      a managed element context; and
      a subnetwork.
5. The method of any of embodiments 3-4 wherein the generic RAN node function comprises an eNB function, a gNB function, a Base Station System (BSS) function, an NB function, a gNB-DU function, or a gNB-CU function.
6. The method of any of embodiments 1-4 wherein the stored element-specific data includes connectivity information for the corresponding element, the method further comprising:
   receiving a request to connect to an element in the network including a location-specific DN for the element;
   identifying the universally unique DN for the element using the received location-specific DN and the associated linking;
   retrieving the connectivity information for the element from the memory using the identified universally unique ON; and
   establishing a connection with the element using the retrieved connectivity information.
7. The method of any of embodiments 1-6 further comprising
   receiving the element-specific data from at least one element in the network, the received element-specific data including a location-specific DN for the element; and
   identifying the universally unique DN for the element using the received location-specific DN and the associated linking;
   wherein storing the element-specific data comprises storing the received data relative to the identified universally unique DN in the memory.
8. The method of any of embodiments 1-7 wherein the element-specific data comprises performance measurements for the corresponding element and/or configuration information for the corresponding element.
9. The method of any of embodiments 1-8 further comprising:
   receiving a notification from a managed element in the network, said notification identifying the location-specific DN and the universally unique DN for an element in the network;
   comparing the received location-specific DN for the element to the location-specific DN linked to the universally unique DN for the element; and
   modifying the location-specific DN and the corresponding linkings if the received location-specific DN does not match the stored location-specific DN for the element.

### Group B Embodiments

B1. A resource management system configured to perform any of the steps of any of the Group A embodiments.
B2. A resource management system comprising:
   processing circuitry configured to perform any of the steps of any of the Group A embodiments; and
   power supply circuitry configured to supply power to the resource management system.
B3. A resource management system comprising:
   processing circuitry and memory, the memory containing instructions executable by the processing circuitry whereby the resource management system is configured to perform any of the steps of any of the Group A embodiments.
B5. A computer program comprising instructions which, when executed by at least one processor of a resource management system, causes the resource management system to carry out the steps of any of the Group A embodiments.
B6. A carrier containing the computer program of embodiment B5, wherein the carrier is one of an electronic signal, optical signal, radio signal, or computer readable storage medium.

1-13. (canceled)

14. A method, performed by a resource management system, to maintain an association between element-specific data and a corresponding element within a network independently of a physical or logical location of the corresponding element within the network to seamlessly accommodate changing locations of the corresponding element; the method comprising, for each of a plurality of elements in the network:
specifying a location-specific Distinguished Name (DN) and a universally unique DN for the corresponding element; wherein the location-specific DN depends on a physical location and/or a logical location of the corresponding element within the network; and wherein the universally unique DN comprises a Universal Unique Identifier (UUID) that is independent of the physical location and/or logical location of the corresponding element within the network;
linking element-specific data captured using the location-specific DN for the corresponding element to element-specific data captured using the universally unique DN for the corresponding element;
storing the element-specific data captured for the corresponding element relative to the universally unique DN in memory of the resource management system;
linking the universally unique DN for the corresponding element to the location-specific DN for the corresponding element to enable the resource management system to access the element-specific data stored relative to the universally unique DN using the location-specific DN; and
storing the location-specific DN, the universally unique DN, and the corresponding linkings in the memory of the resource management system.

15. The method of claim 14, further comprising:
responsive to information indicating a new physical location and/or a new logical location of one of the plurality of elements, changing the corresponding location-specific DN to specify an updated location-specific DN;
linking the stored universally unique DN to the updated location-specific DN using a revised linking; and
replacing the location-specific DN and the linking stored in the memory with the updated location-specific DN and the revised linking, respectively.

16. The method of claim 14:
wherein at least one of the plurality of elements comprises a cell within the network; and
wherein the location-specific DN comprises a DN representing:
a generic cell;
a generic Radio Access Network (RAN) node function; and
a managed element.

17. The method of claim 16, wherein the generic RAN node function comprises an eNB function, a gNB function, a Base Station System (BSS) function, an NB function, a gNB-DU function, or a gNB-CU function.

18. The method of claim 14:
wherein at least one of the plurality of elements comprises a cell within the network; and
wherein the location-specific DN comprises a DN representing:
a generic cell;
a generic Radio Access Network (RAN) node function;
a managed element;
a managed element context; and
a subnetwork.

19. The method of claim 18, wherein the generic RAN node function comprises an eNB function, a gNB function, a Base Station System (BSS) function, an NB function, a gNB-DU function, or a gNB-CU function.

20. The method of claim 14:
wherein the stored element-specific data includes connectivity information for the corresponding element;
wherein the method further comprises:
receiving a request to connect to an element in the network, the request including a location-specific DN for the element;
identifying the universally unique DN for the element using the received location-specific DN and the associated linking stored in the memory;
retrieving the connectivity information for the element from the memory using the identified universally unique DN; and
establishing a connection with the element using the retrieved connectivity information.

21. The method of claim 14, further comprising
receiving the element-specific data from at least one element in the network, the received element-specific data including a location-specific DN for the element;
identifying the universally unique DN for the element using the received location-specific DN and the associated linking stored in the memory;
wherein the storing the element-specific data comprises storing the received element-specific data relative to the identified universally unique DN in the memory.

22. The method of claim 14, wherein the element-specific data comprises performance measurements for the corresponding element and/or configuration information for the corresponding element.

23. The method of claim 14, further comprising:
receiving a notification from a managed element in the network, the notification identifying the location-specific DN and the universally unique DN for an element in the network;
comparing the received location-specific DN for the element to the location-specific DN linked to the universally unique DN for the element; and
modifying the location-specific DN and the corresponding linkings if the received location-specific DN does not match the stored location-specific DN for the element.

24. A resource management system for maintaining an association between element-specific data and a corresponding element within a network independently of a physical or logical location of the corresponding element within the network to seamlessly accommodate changing locations of the corresponding element, the resource management system comprising:
processing circuitry;
memory containing instructions executable by the processing circuitry whereby the resource management system is operative to, for each of a plurality of elements in the network:
specify a location-specific Distinguished Name (DN) and a universally unique DN for the corresponding element; wherein the location-specific DN depends on a physical location and/or a logical location of the corresponding element within the network; and wherein the universally unique DN comprises a Universal Unique Identifier (UUID) that is independent of the physical location and/or logical location of the corresponding element within the network;
link element-specific data captured using the location-specific DN for the corresponding element to element-specific data captured using the universally unique DN for the corresponding element;
store the element-specific data captured for the corresponding element relative to the universally unique DN in memory of the resource management system;
link the universally unique DN for the corresponding element to the location-specific DN for the corresponding element to enable the resource management system to access the element-specific data stored relative to the universally unique DN using the location-specific DN; and
store the location-specific DN, the universally unique DN, and the corresponding linkings in the memory of the resource management system.

25. The resource management system of claim 24, wherein the instructions are such that the resource management system is operative to:
change, responsive to information indicating a new physical location and/or a new logical location of one of the plurality of elements, the corresponding location-specific DN to specify an updated location-specific DN;
link the stored universally unique DN to the updated location-specific DN using a revised linking; and
replace the location-specific DN and the linking stored in the memory with the updated location-specific DN and the revised linking, respectively.

26. A non-transitory computer readable recording medium storing a computer program product for controlling a resource management system, for maintaining an association between element-specific data and a corresponding element within a network independently of a physical or logical location of the corresponding element within the network to seamlessly accommodate changing locations of the corresponding element; the computer program product comprising program instructions which, when run on processing circuitry of the resource management system, causes the resource management system to:
specify a location-specific Distinguished Name (DN) and a universally unique DN for the corresponding element; wherein the location-specific DN depends on a physical location and/or a logical location of the corresponding element within the network; and wherein the universally unique DN comprises a Universal Unique Identifier (UUID) that is independent of the physical location and/or logical location of the corresponding element within the network;
link element-specific data captured using the location-specific DN for the corresponding element to element-specific data captured using the universally unique DN for the corresponding element;
store the element-specific data captured for the corresponding element relative to the universally unique DN in memory of the resource management system;
link the universally unique DN for the corresponding element to the location-specific DN for the corresponding element to enable the resource management system to access the element-specific data stored relative to the universally unique DN using the location-specific DN; and
store the location-specific DN, the universally unique DN, and the corresponding linkings in the memory of the resource management system.

27. The non-transitory computer readable recording medium of claim 26, wherein the instructions are such that the resource management system is operative to:
change, responsive to information indicating a new physical location and/or a new logical location of one of the plurality of elements, the corresponding location-specific DN to specify an updated location-specific DN;
link the stored universally unique DN to the updated location-specific DN using a revised linking; and
replace the location-specific DN and the linking stored in the memory with the updated location-specific DN and the revised linking, respectively.
